(19) United States
(12) Patent Application Publication
(10) Pub. No.: US 2026/0273736 A1
(43) Pub. Date: Sep. 17, 2026

(54) Controlling Stability of Mobile Manipulators by Mobile Base Motions

(71) Applicant: ABB Schweiz AG, Baden (CH)

(72) Inventors: Arne-Christoph Hildebrandt, München (DE); Jonas Larsson, Västerås (SE); Christoph Bick, Augsburg (DE)

(73) Assignee: ABB Schweiz AG, Baden (CH)

(21) Appl. No.: 19/669,384

(22) Filed: May 6, 2026

Related U.S. Application Data
(63) Continuation of application No. PCT/EP2023/081088, filed on Nov. 8, 2023.

(51) Int. Cl. B25J 9/16; B25J 5/00

(52) U.S. Cl. CPC B25J 9/1628; B25J 5/007

(57) ABSTRACT

A method for controlling a mobile manipulator includes determining a current configuration, determining a desired movement trajectory, determining a current zero-movement points (ZMP) trajectory, determining a desired ZMP trajectory of the mobile manipulator, wherein each ZMP is located within a support polygon of the manipulator base, adjusting the mobile manipulator such that the current ZMP trajectory corresponds to the desired ZMP trajectory using a dynamic manipulator arm movement controlled by:

$$f ( {ZMP}_{real} ( {\ddot{q}}_{M} , {\dot{q}}_{M} , {q}_{M} , {\ddot{q}}_{B R} , {\dot{q}}_{B R} , {q}_{B R} , t ) , {ZMP}_{d e s} ( t ) ) = min e$$

wherein “ZMP_{des}(t)” is the desired ZMP trajectory; “ZMPᵣₑₐₗ” is the real ZMP trajectory; “t” is a time; “\ddot{q}_{M}, \dot{q}_{M}, q_{M},” are joint states of acceleration, velocity and position of the manipulator arm; “q_{BR}, \dot{q}_{BR}, \ddot{q}_{BR}” are a rotation position, rotation velocity and rotation acceleration of the manipulator base, and “e” is a deviation of the real ZMP trajectory from the desired ZMP trajectory.

### CROSS-REFERENCE TO RELATED APPLICATIONS

The instant application claims priority to International Patent Application No. PCT/EP2023/081088, filed Nov. 8, 2023, which is incorporated herein in its entirety by reference.

### FIELD OF THE DISCLOSURE

The present disclosure generally relates to a method for controlling a mobile manipulator, a mobile manipulator, a computer program product, and a computer-readable medium.

### BACKGROUND OF THE INVENTION

In recent years, automation industry is focusing more and more on automating applications in industries with limited space. These applications often consist of combinations of transportation tasks in laboratory environments and pick & place tasks on different workplaces. A robot type, which is proposed to answer these needs, is the mobile manipulator. It combines a mobile base with an attached manipulator. Due to limited space in laboratory environments, the requirements on the size of these robots are increasing. Especially the footprint size of the robot is in the focus for optimization. Common manipulators often comprise a heavy and large base, which may be disadvantageous when the robots should operate in constrained spaces. In addition to the size of the robot, the overall time the robot needs to execute tasks has to be constantly decreased. This need leads to higher acceleration of the mobile base while navigating and while executing pick and place tasks. A challenge that arises from these requirements is to ensure that the robot stays stable and, for instance, does not tip over. Problems at the stability may occur with higher dynamic forces which therefore increases the challenge to ensure the stability of the robot.

Thus, there is a need for sophisticated approaches to prevent an instability of a mobile manipulator.

### BRIEF SUMMARY OF THE INVENTION

The present disclosure generally describes a method for controlling a mobile manipulator comprising a manipulator base and at least one manipulator arm. The method includes determining a current configuration of the mobile manipulator including a manipulator arm configuration and a manipulator base configuration; determining a desired movement trajectory of the mobile manipulator; determining a current zero-movement points (ZMP) trajectory, comprising the location of one or more current ZMP of the mobile manipulator, based on the current configuration of the mobile manipulator and the desired movement trajectory; determining a desired ZMP trajectory of the mobile manipulator, wherein each ZMP is located within a support polygon of the manipulator base; adjusting the mobile manipulator such that the current ZMP trajectory corresponds to the desired ZMP trajectory.

In the method according to the present invention, the step of adjusting the mobile manipulator comprises a dynamic manipulator arm movement, which is controlled by the following first control function:

$$f ( {ZMP}_{real} ( {\ddot{q}}_{M} , {\dot{q}}_{M} , {q}_{M} , {\ddot{q}}_{B R} , {\dot{q}}_{B R} , {q}_{B R} , t ) , {ZMP}_{d e s} ( t ) ) = m i n e$$

wherein “ZMP_{des}(t)” is the desired ZMP trajectory; “ZMPᵣₑₐₗ” is the real ZMP trajectory; “t” is a time; “\ddot{q}_{M}, \dot{q}_{M}, q_{M},” are joint states of acceleration, velocity and position of the manipulator arm; “q_{BR}, \dot{q}_{BR}, \ddot{q}_{BR}” are a rotational position, rotational velocity and rotational acceleration of the manipulator base, and “e” is a deviation of the real ZMP trajectory from the desired ZMP trajectory.

Accordingly, a flexible method for stabilizing mobile manipulators using dynamic arm movements and rotations of the manipulator base during the movement of the mobile manipulator along a distinct path, which ensures that the mobile manipulator may stay stable and may accordingly not tip over during the movement, is provided. The respective states of acceleration, velocity and position of the manipulator arm and the rotations of the manipulator base may be accordingly determined by respective suitable detection means, such as detectors or sensors, of the mobile manipulator. The control of the dynamic manipulator arm movement and the rotations of the manipulator base may be performed by respective control means, which may receive the respective information about the joint states of acceleration, velocity and position of the manipulator arm and the rotation of the manipulator base. The control means may comprise suitable computing and controlling means for controlling any elements of the mobile manipulator, for instance an orientation or extension of the manipulator arm and/or a propelling speed, acceleration or a steering of the wheels, e.g. for a translational or rotational movement of the manipulator base. The control means and controlling means may comprise respective computing means suitable to control a dynamic movement of the manipulator arm based on the respective input parameters. Further, the control means and controlling means may comprise respective computing means suitable to control a rotation of the manipulator base based on the respective input parameters. The manipulator arm adjustment and the rotation of the manipulator base may be performed dynamically during the movement of the mobile manipulator.

### BRIEF DESCRIPTION OF THE SEVERAL VIEWS OF THE DRAWING(S)

For a better understanding of the present invention, and to illustrate its practicality, figures are provided in the following and reference is made thereto. It should be understood that the figures represent only exemplary embodiments and thus in no way limit the scope of the claimed invention. Identical or like-acting elements are indicated throughout by the same reference signs. Any reference signs in the claims should not be construed as limiting the scope of the claims.

In the accompanying drawings,

FIGS. 1A and 1B schematically illustrate a mobile manipulator according to the present invention in different configurations;

FIG. 2 is a flowchart illustrating a method for controlling a mobile manipulator according to the present invention;

FIG. 3 is a flowchart illustrating a method for controlling a mobile manipulator according to the present invention;

FIG. 4 is a flowchart illustrating a method for controlling a mobile manipulator according to the present invention;

FIG. 5 is a flowchart illustrating a method for controlling a mobile manipulator according to the present invention.

### DETAILED DESCRIPTION OF THE INVENTION

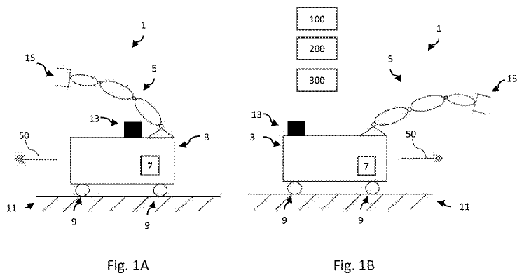

FIGS. 1A and 1B depict a mobile manipulator 1 according to the present invention. The mobile manipulator 1 comprises a manipulator base 3 and a manipulator arm 5 attached at the top side of mobile base 3. It will be understood that in different embodiments, also more than one manipulator arm 5 may be provided and that the position of the one or more manipulator arms 5 may vary, e.g., the manipulator arm 5 may be provided at the front or back side or at a lateral side of the of the mobile manipulator 1. The mobile manipulator arm 5 is formed as a movable arm comprising multiple arm elements which are linked together to allow a flexible movement and extension or retraction of the arm. However, it will be understood that in different environments also a stiff manipulator arm may be provided consisting for instance only of a single stiff arm element movably attached to the manipulator base 3. The manipulator arm 5 is hinged at a proximal end of the manipulator arm 5 with the mobile phase 3 and comprises a tool center point, TCP, 15 at the distal end of the manipulator arm. In the depicted embodiment, the TCP 15 is formed as a gripper to allow a grip of an external item or load. The manipulator base 3 comprises contact elements 9 in form of wheels to contact the floor 11. Thus, the mobile manipulator 1 may be moved along the floor 11. During movement of the mobile manipulator 1, the manipulator arm 5 may be dynamically adjustable, such that different arm positions may be provided. For instance, when the mobile manipulator 1 moves along a certain movement trajectory comprising multiple tracks, a distinct arm position may be assumed, as shown in FIG. 1A, at a first movement path section. A different distinct arm position, as shown in FIG. 1B, may be accordingly provided at a second first movement path section. In FIG. 1A, the mobile manipulator 1 moves towards the left side, as depicted by arrow 50. In FIG. 1B, the mobile manipulator one moves towards the right side, as depicted by arrow 50. The mobile manipulator 1 may be moved along a predefined movement trajectory and the mobile base 3 may be rotated during the movement.

The mobile manipulator 1 further comprises a mass element 13, arranged at the top surface of the manipulator base 3. However, in different embodiments of the present invention, no additional mass elements are provided. As shown, the mass element 13 can be located at different positions with respect to the manipulator base 3. For instance, as shown in FIG. 1A, the mass element 13 is arranged at the right side of the manipulator base 3, close to the proximal side of the manipulator arm 5 at which it is attached to the manipulator base 3. It will be understood that in different embodiments also more than one mass element 13 may be provided and that the position of the one or more mass elements 13 may vary. Further, as shown in FIG. 1B, the mass element 13 is arranged at the left side of the manipulator base 3, spaced from the proximal side of the manipulator arm 5 to counteract a shift of the center of mass by the depicted manipulator arm configuration. As shown in FIGS. 1A and 1B, the movable arm manipulator arm 5 may have different orientations with respect to the manipulator base 3.

The orientations of the manipulator arm 5 may be set and controlled by the control means 7 of the mobile manipulator 1. In the depicted embodiment, the control means 7 is arranged at the mobile manipulator 1. However, it will be understood that in different embodiments, the control means 7 can also be arranged at least partially outside of or remote from the mobile manipulator 1. The control means 7 may comprise suitable sensing, computing and controlling means for controlling the elements of the mobile manipulator 1, for instance an orientation of the manipulator arm 5 or a propelling speed, acceleration and direction of the wheels. Dependent on the configuration of the manipulator arm 5, the center of mass of the mobile manipulator 1 changes. For instance, due to the manipulator arm configuration, the center of mass of the mobile manipulator 1 of FIG. 1B shifts more to the right compared to the center of mass of the manipulator 1 of FIG. 1A because the manipulator arm 5 in FIG. 1B extends further beyond and away from the manipulator base 3 compared to the configuration of FIG. 1A. As noted above, this is counteracted by the positioning of the mass element 13. In a different embodiment, a center of mass may be shifted by changing only a manipulator arm configuration, e.g., a position of the manipulator arm 5.

When the center of mass is shifted too far, the mobile manipulator 1 may be in an unstable condition such that a tipping of the mobile manipulator 1 may occur. This may be counteracted, for instance, by controlling the orientation of the manipulator arm 5 to one or more proper positions. Thus, when the mobile manipulator 1 moves along the predefined movement trajectory, for instance along different distinct paths of an industrial, scientific or medical site, the manipulator arm 5 may be controlled according to the present invention to assume different configurations to maintain stable condition during movement. This may include setting a first arm configuration at a first travel path or section and to set a different a second configuration at a second travel path or section.

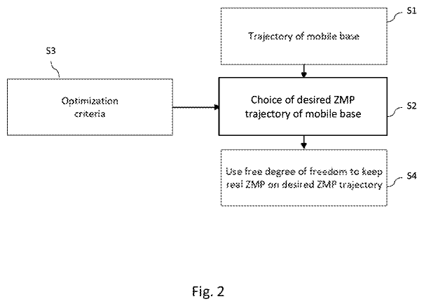

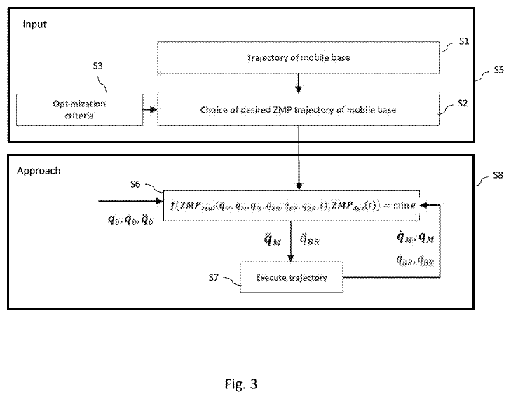

Further, a computer-program product 200 and a computer-readable medium 300 are shown, each comprising instructions, which, when executed by a computer 100, cause the computer 100 to carry out and/or control the method of any embodiments of the present invention, in particular the method as illustrated in FIGS. 2 and 3. In the depicted embodiment, the computer 100, the computer-program product 200 and the computer-readable medium 300 are depicted as external elements. However, it will be understood that in different embodiments, any of the computer 100, the computer-program product 200 and the computer-readable medium 300 may be at least partly integrated in the mobile manipulator 1.

FIG. 2 depicts a flowchart illustrating a method for controlling a mobile manipulator 1 according to an embodiment of the present invention. In step S1 of the depicted embodiment, a desired movement trajectory of the mobile base 3 or the mobile manipulator 1 is determined. In step S2 of the depicted embodiment, based on the desired movement trajectory, the desired ZMP trajectory of the mobile base 3 or the mobile manipulator 1 is chosen or determined. As shown in step S3, optimization criteria may be introduced to improve the overall performance of the mobile manipulator 1. Such optimization criteria may be any suitable criteria for optimizing a mobile manipulator action such as, for instance, the requirement to employ the lowest possible acceleration or the highest possible speed or to reduce the power consumption of the mobile manipulator 1. In step S4, which is explained in greater detail further below, the ZMP trajectory is used as input for the definition of the motion of the mobile manipulator 1 to exploit the redundant degrees of freedom. The free degrees of freedom can be accordingly used to keep the current ZMP trajectory of the mobile manipulator 1 on the desired ZMP trajectory of the mobile manipulator 1.

FIG. 3 depicts a flowchart illustrating a method for controlling a mobile manipulator 1 according to an embodiment of the present invention. As depicted, the steps S1 to S3 correspond to the steps S1 to S3 of FIG. 2, wherein the output of steps S1 to S3 form an input (S5) for the following steps. In FIG. 3, denoted as “approach” (cf. S8), one embodiment of the step S4 of FIG. 2 is explained in greater detail. Herein, the output of step S2 is used as an input for step S6, wherein in step S6 the current or real ZMP trajectory of the mobile manipulator 1 is determined or predicted. A dynamic manipulator arm movement may be accordingly provided, which is controlled by the following first control function:

$$f ( {ZMP}_{real} ( {\ddot{q}}_{M} , {\dot{q}}_{M} , {q}_{M} , {\ddot{q}}_{B R} , {\dot{q}}_{B R} , {q}_{B R} , t ) , {ZMP}_{d e s} ( t ) ) = m i n e$$

wherein “ZMP_{des}(t)” is the desired ZMP trajectory; “ZMPᵣₑₐₗ” is the real ZMP trajectory; “t” is a time; “\ddot{q}_{M}, \dot{q}_{M}, q_{M},” are joint states of acceleration, velocity and position of the manipulator arm 5; “q_{BR}, \dot{q}_{BR}, \ddot{q}_{BR}” are a rotational position, rotational velocity and rotational acceleration of the manipulator base 3, and “e” is a deviation of the real ZMP trajectory from the desired ZMP trajectory.

From the first control function described in step S6, the joint accelerations of the manipulator arm 5 “\ddot{q}_{M}” and/or the rotational acceleration “\ddot{q}_{BR}” may be obtained as an output. Based on that output, a movement trajectory of the mobile manipulator 1 is executed in step S7. After executing the movement trajectory of the mobile manipulator 1 based on that output, the remaining states of position and velocity “q_{M}, \dot{q}_{M}” and/or the rotational position and velocity “q_{BR}, \dot{q}_{BR}” of the manipulator base 3 are used as an input for the first control function of step S6. In a different embodiment, different outputs may be obtained, such as the state of velocity “\dot{q}_{M}” of the manipulator arm 5 or the state of position “q_{M}” of the manipulator arm 5 and an execution of the movement trajectory of the mobile manipulator 1 may be based on that different output. Likewise, in a different embodiment, different outputs may be obtained, such as the rotational velocity “\dot{q}_{BR}” of the manipulator base 3 or the rotational position “q_{BR}” of the manipulator base 3 and an execution of the movement trajectory of the mobile manipulator 1 may be based on that different output. Accordingly, also different inputs may be used as an input for the first control function of step S6, such as the state of acceleration “\ddot{q}_{M}” of the manipulator arm 5 and/or the rotational acceleration “\ddot{q}_{BR}” of the manipulator base 3. As depicted, “q₀, \dot{q}₀, \ddot{q}₀”, which are the initial states of position, velocity and acceleration of the mobile manipulator 1 are used as further input variables for the first control function of step S6.

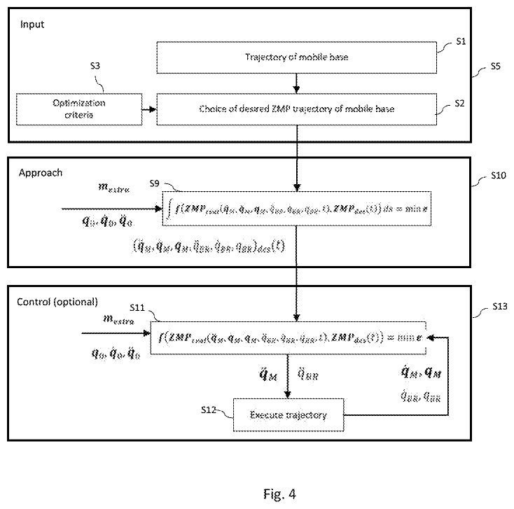

In FIG. 4, another embodiment for controlling a mobile manipulator 1 is depicted. Herein, the steps S1 to S3 correspond to the steps S1 to S3 of FIGS. 2 and 3, and the output of steps S1 to S3 forms an input (cf. S5 denoted as “input”) for the following steps. In FIG. 4, denoted as “approach” (cf. S10), one embodiment of the step S4 of FIG. 2 is explained in greater detail. Herein, the output of step S2 is used as an input for step S9, wherein in step S9, the current or real ZMP trajectory of the mobile manipulator 1 is determined or predicted. A dynamic manipulator arm movement and/or a rotational movement of the manipulator base 3 may be accordingly provided, which is controlled by the following second control function of step S9, which may be also referred to as planning function:

$$\int f ( {ZMP}_{real} ( {\ddot{q}}_{M} , {\dot{q}}_{M} , {q}_{M} , {\ddot{q}}_{B R} , {\dot{q}}_{B R} , {q}_{B R} , t ) , {ZMP}_{d e s} ( t ) ) d s = m i n e$$

From the second control function of step S9, the desired state of the manipulator arm 5 “(\ddot{q}_{M}, \dot{q}_{M}, q_{M}, \ddot{q}_{BR}, \dot{q}_{BR}, q_{BR}) _{des}(t)” can be obtained as an output. As depicted, “q₀, \dot{q}₀, \ddot{q}₀”, which are the initial states of position, velocity and acceleration of the mobile manipulator 1 are used as further input variables for the second control function S9. Furthermore, a discrete mass parameter “mₑₓₜᵣₐ” can be used as an input variable for the second control function of step S9. In a different embodiment, no discrete mass parameter “mextra” is used as an input variable for the second control function of step S9. The output of the second control function of step S9 may optionally also be used as an input for a subsequent control approach (cf. S13, denoted as “control (optional)”). Herein, the first control function of step S11 basically corresponds to the first control function of step S6 of FIG. 3. As depicted, “q₀, q_{\dot{0}}, \ddot{q}₀.”, which are the initial states of position, velocity and acceleration of the mobile manipulator 1 are used as further input variables for the first control function of step S11. Furthermore, a discrete mass parameter “mₑₓₜᵣₐ” can be used as an input variable for the first control function of step S11. In a different embodiment, no discrete mass parameter “mₑₓₜᵣₐ” is used as an input variable for the first control function of step S11.

Similar to the control approach of FIG. 3 (cf. S8), from the first control function described in step S11, the joint accelerations of the manipulator arm 5 “\ddot{q}_{M}” and/or the rotational acceleration “\ddot{q}_{BR}” of the manipulator base 3 may be obtained as an output. Based on that output a movement trajectory of the mobile manipulator 1 is executed in step S12. After executing the movement trajectory of the mobile manipulator 1 based on that output, the remaining states of position and velocity “q_{M}, \dot{q}_{M}” and/or the rotational position and velocity “q_{BR}, \dot{q}_{BR}” are used as an input for the first control function of step S11. In a different embodiment, different outputs may be obtained, such as the state of velocity “q_{M}” of the manipulator arm 5 or the state of position “q_{M}” of the manipulator arm 5 and an execution of the movement trajectory of the mobile manipulator 1 may be based on that different output. Likewise, in a different embodiment, different outputs may be obtained, such as the rotational velocity “\dot{q}_{BR}” of the manipulator base 3 or the rotational position “q_{BR}” of the manipulator base 3 and an execution of the movement trajectory of the mobile manipulator 1 may be based on that different output. Accordingly, also different inputs may be used as an input for the first control function of step S11, such as the state of acceleration “\ddot{q}_{M}” of the manipulator arm 5 and/or the rotational acceleration “\ddot{q}_{BR}” of the manipulator base 3.

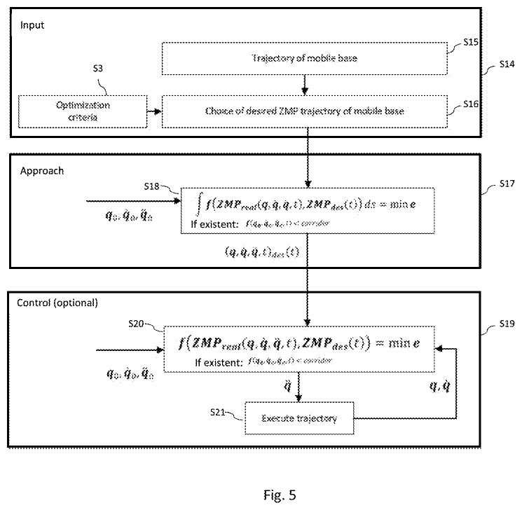

The control approach depicted in FIG. 5 basically corresponds to the control approach depicted in FIG. 4 with the difference that in FIG. 5 the movement is restricted by spatial constraints such as a corridor. In FIG. 5, denoted as “approach” (cf. S17), one embodiment of the step S4 of FIG. 2 is explained in greater detail. Herein, the output of step S16 is used as an input for step S18, wherein in step S18 the current or real ZMP trajectory of the mobile manipulator 1 is determined or predicted. Contrary to the previous approach of FIG. 4, not only the movement of the manipulator arm is considered but the movement of the whole manipulator, including a movement of the manipulator arm 5 and the manipulator base 3.

Thus, a movement may be accordingly provided, which is controlled by the following second control function of step S18, which may be also referred to as planning function:

$$\int f ( {ZMP}_{real} ( q , \dot{q} , \ddot{q} , t ) , {ZMP}_{d e s} ( t ) ) d s = m i n e$$

Different to the second control function of step S9 of FIG. 4, when the movement of the mobile manipulator is delimited by a corridor, the second control function comprises an additional constraint:

$$f ( {q}_{B} , {\dot{q}}_{B} , {\ddot{q}}_{B} , t ) < corridor$$

wherein “q_{B}, \dot{q}_{B}, \ddot{q}_{B}” are the degrees of freedom of the position, the velocity and the acceleration of the manipulator base 3 and “corridor” is a constraint value defined by the dimensions of the corridor the mobile manipulator 1 is moving through.

From the second control function of step S18, the desired state of the mobile manipulator 1 “(\ddot{q}, \dot{q}, q)_{des}(t)” can be obtained as an output. As depicted, “q₀, \dot{q}₀, \ddot{q}₀”, which are the initial states of position, velocity and acceleration of the mobile manipulator 1 are used as further input variables for the second control function S18. In a different embodiment, a discrete mass parameter “mₑₓₜᵣₐ” may be additionally used as an input variable for the second control function of step S18 (cf. FIG. 4). The output of the second control function of step S18 may optionally also be used as an input for a subsequent control approach (cf. S19, denoted as “control (optional)”), wherein in step S20 the current or real ZMP trajectory of the mobile manipulator 1 is determined or predicted. Herein, a dynamic manipulator movement could be provided, which is controlled by the following first control function:

$$f ( {ZMP}_{real} ( q , \dot{q} , \ddot{q} , t ) , {ZMP}_{d e s} ( t ) ) = min e$$

wherein “ZMP_{des}(t)” is the desired ZMP trajectory; “ZMPᵣₑₐₗ” is the real ZMP trajectory; “t” is a time; “q, \dot{q}, \ddot{q}” are the joint states of position, velocity and acceleration of the mobile manipulator 1 and “e” is a deviation of the real ZMP trajectory from the desired ZMP trajectory.

Herein, the first control function of step S20 basically corresponds to the first control function of step S6 of FIGS. 3 and S11 of FIG. 4 with the difference that, when the movement of the mobile manipulator 1 is delimited by a corridor, the first control function comprises the additional constraint:

$$f ( {q}_{B} , {\dot{q}}_{B} , {\ddot{q}}_{B} , t ) < corridor$$

As depicted, “q₀, \dot{q}₀, \ddot{q}₀”, which are the initial states of position, velocity and acceleration of the mobile manipulator 1 are used as further input variables for the first control function of step S20. In a different embodiment, a discrete mass parameter “mₑₓₜᵣₐ” may be additionally used as an input variable for the first control function of step S20 (cf. FIG. 4).

Similar to the control approaches of FIG. 3 (cf. S8) and FIG. 4 (cf. S13), from the first control function described in step S20, the joint accelerations of the mobile manipulator 1 “\ddot{q}” may be obtained as an output. Based on that output a movement trajectory of the mobile manipulator 1 is executed in step S21. After executing the movement trajectory of the mobile manipulator 1 based on that output, the remaining states of position and velocity “q, \dot{q}” of the mobile manipulator 1 are used as an input for the first control function of step S20. In a different embodiment, different outputs may be obtained, such as the state of velocity “\dot{q}” of the mobile manipulator 1 or the state of position “q” of the mobile manipulator 1 and an execution of the movement trajectory of the mobile manipulator 1 may be based on that different output. Accordingly, also different inputs may be used as an input for the first control function of step S20, such as the state of acceleration “\ddot{q}” of the mobile manipulator 1.

It will be understood that the method according to the present invention is not limited to the above noted order of method steps. Quite to the contrary, the method steps may be also provided in a different order and one or more of the above noted method steps may be removed or further method steps may be added, as desired.

In the context of the present disclosure, the mobile manipulator may be understood as any kind of movable robot. “Mobile” or “movable” manipulators in this context may be understood such that the manipulator may assume different positions or locations on the ground. The position of the mobile manipulator may be accordingly changed. For instance, the mobile manipulator may move itself or is moved by respective means from a starting point to an end point via a predetermined distinct travel path.

The manipulator arm may be any type of mechanical arm. The manipulator arm may comprise multiple elements linked with each other and the mobile base to form a kinematic chain. The links of such a manipulator arm may be connected by respective joints allowing for instance a rotational motion or a linear translational displacement. However, it will be understood that the manipulator arm may also comprise only one stiff element linked to the manipulator base. The manipulator arm may be programmable for allowing execution of respective movements for performing different tasks. Also, more than one manipulator arm may be provided.

The manipulator base may essentially define the core body of the mobile manipulator, at which the manipulator arm is attached. A rotation of the manipulator base may be achieved by that the mobile manipulator is an omnidirectional movable mobile manipulator that allows an omnidirectional movement of the manipulator base. Thus, the mobile manipulator may be allowed to perform a transversal movement and a rotational movement at the same time. The manipulator base may house respective propelling or controlling means such as the power supply, one or more motors and/or computing devices and may be enclosed by a housing to protect the mobile manipulator elements arranged inside from negative impacts, such as dust and moisture. The manipulator base may define the support polygon. The support polygon may be a surface area upon which the mobile manipulator is supported or carried on the ground. The support polygon may comprise three, four or more edges or may have a circular, oval or of any other two-dimensional shape.

The current configuration of the mobile manipulator may include information about the extension and/or the weight of the respective parts of the mobile manipulator. For instance, the current configuration may include information about a center of mass of each component and/or the whole mobile manipulator. The manipulator arm configuration may include an extension or orientation of the manipulator arm with respect to the manipulator base, e.g. an angle of rotation or an extension of the manipulator arm. The manipulator base configuration may include information about the manipulator bases' weight or the dimensions of the manipulator base, such as, for instance, the dimension of a lower base surface of the manipulator base, which may form the support polygon. Any suitable parameter concerning the center of mass of the mobile manipulator may be included.

The location at which the manipulator arm is attached to the manipulator base may be fixed or may vary. The manipulator arm may be provided at any desired side of the manipulator base, for instance at a top side, a front or back side, or at one of the lateral sides of the mobile manipulator. The manipulator arm configuration may include a distinct position and/or orientation of the manipulator arm in space, such as an arm stance. The manipulator arm configuration may comprise an information about the rotational position of the manipulator arm or an extension of the manipulator arm, e.g. an extension beyond the manipulator base. The manipulator base configuration may accordingly comprise a spatial extension and a weight or weight distribution of the manipulator base.

The desired movement trajectory may be a trajectory or path the mobile manipulator may take on a ground. Thus, the desired movement trajectory may be provided in an essentially horizontal two-dimensional plane. The mobile manipulator may move on the ground along the desired movement trajectory from a start position to an intermediate or end-position. The desired movement trajectory may be based on one or more tasks the mobile manipulator should perform, e.g. to pick up an item at a first position and to place said item at a second position. The movement trajectory may comprise one or more straight movements or curved movements, or any other arbitrary geometrical movement on the ground between the start position and the end-position. The desired movement trajectory may comprise intermediate positions, at which the mobile manipulator may change its direction of motion. For instance, the mobile manipulator may pick up an item at a start position and move along the desired movement trajectory towards an end position to drop said item at this end position. The mobile manipulator may accordingly continue to a third point with or without picking up the same or a different item and/or may return to its start position. The manipulator arm configuration may preferably include a dynamic movement of the manipulator arm.

A ZMP may be understood as a point at which reaction forces of a contact between mobile manipulator and the ground do not produce any moment in the horizontal direction, i.e. in a direction of a plane in which the mobile manipulator moves. This may be a direction in a plane essentially perpendicular to a direction of gravity. In a common notation, a plane in which the mobile manipulator moves, may extend in a x-y-direction and the direction of gravity is in a z-direction. The ZMP may be considered as the point where the sum of horizontal moments Mₓ, and M_{y} is zero. In other words, the ZMP may be defined as the reference point in the contact plane between robot and ground, for which the horizontal components of the contact moment vanish. The ZMP of the mobile manipulator may depend on the manipulator arm configuration, the manipulator base configuration, e.g. the extension of the support polygon, and the desired movement trajectory. One or more ZMP may be determined or predicted for the mobile manipulator. A determination may also be understood as a prediction in the current disclosure. Any ZMP may depend on a configuration of the mobile base and the manipulator arm including, for instance, a weight and spatial extension of said components and their respective arrangement with respect to each other.

Based on the current configuration of the mobile manipulator, a current ZMP trajectory may be determined or predicted. The current ZMP trajectory may correspond to one or more predicted ZMP locations of the mobile manipulator when the mobile manipulator would move along the desired movement trajectory. The mobile manipulator may be considered stable when its predicted current ZMP are located within the support polygon. If the one or more predicted current ZMP of the mobile manipulator are arranged in the support polygon, the mobile manipulator may be stable such that no tipping over may occur during the movement along the desired movement trajectory. Thus, in the method of the present invention, the mobile manipulator may be preferably configured such that its ZMP are located in the support polygon, thus allowing for a stable movement or standstill.

Accordingly, knowing the desired movement trajectory of the mobile manipulator and considering the mobile manipulators' configuration, e.g. based on the arm configuration, a desired ZMP trajectory may be determined or predicted, which may allow for a stable movement of the mobile manipulator when moving along the desired movement trajectory. If the mobile manipulator would move along the desired movement trajectory, and its ZMP correspond or are sufficiently close to the desired ZMP trajectory, stable movement of the mobile manipulator may be achieved.

Thus, the mobile manipulator may be accordingly adjusted such that the current ZMP trajectory may correspond or may be close to the desired ZMP trajectory to achieve a stable movement of the mobile manipulator. This adjustment may be performed before or during the movement of the mobile manipulator. For different sections of the movement trajectory, different adjustments of the mobile manipulator may be provided to obtain stable configuration.

For instance, if a ZMP would lie outside or is too far away from the desired ZMP trajectory, a mobile manipulator might accordingly become unstable during movement. Hence, a suitable adjustment of the mobile manipulator, e.g. regarding the manipulator arm, may be determined and performed. The manipulator arm may be, for instance, adjusted in its orientation or position from a first position to a second position, such that a center of mass, and accordingly the ZMP of the mobile manipulator, may be shifted towards a more central position of the mobile manipulator, thus providing an increased stability. The mobile manipulator may be accordingly adjusted such that it might be no longer unstable when it would move along the desired movement trajectory.

The center of mass may comprise the masses and dimensions of the whole mobile manipulator or may only comprise the masses and dimensions of individual parts. This may be, for instance, the largest parts or parts, which have the largest impact on the position of the center of mass of the mobile manipulator.

In some examples, the adjustment of the mobile manipulator may include an adjustment of the manipulator arm, e.g. a certain rotation of the arm, to shift the center of mass. Or the adjustment of the mobile manipulator may include an adjustment of an extension or reach of the manipulator arm with respect to the manipulator base to avoid a tipping over of the mobile manipulator. Additionally, or alternatively, the adjustment of the mobile manipulator may include a rotation of the manipulator base. Further adjustments may consider the addition, removal or change of position of weight associated with the mobile manipulator.

In the approach of the present invention, a control strategy based on the ZMP criteria could be formulated. The desired ZMP trajectory may be based on the current motions of the mobile base. The desired ZMP trajectory may be required to respect the ZMP criteria and may have to lie inside the support polygon. Its exact location inside the polygon may be not restricted and may be used to optimize further criteria, for instance regarding energy optimality. Using the desired ZMP trajectory as reference trajectory, a control problem according to the present invention may be set up. Herein, input variables, such as the acceleration of joints of the manipulator \ddot{q}_{M} may be used. Thus, a control function ƒ may be used to minimize the deviation of the real or current ZMP trajectory from the desired ZMP trajectory. This approach may allow for dynamic arm motions to achieve that the current ZMP trajectory corresponds to the desired ZMP trajectory.

In a preferred embodiment, the method further comprises the step of using “q₀, \dot{q}₀, \ddot{q}₀” as input variables for the first control function, wherein “q₀, \dot{q}₀, \ddot{q}₀” are the initial states of position, velocity and acceleration of the mobile manipulator.

The initial states may be accordingly determined by respective suitable detection or sensing means, which may be, for instance, associated with control means of the mobile manipulator. Said detection means may be the same means or different means as the detection means for determining the respective states of acceleration, velocity and position of the manipulator arm.

In a preferred embodiment, the method further comprises the step of the method further comprises the step of using the first control function to adjust one or more of the position, velocity and acceleration of the manipulator arm and/or the rotation position, rotation velocity and rotation acceleration of the manipulator base to adjust the mobile manipulator such that the real ZMP trajectory of the mobile manipulator corresponds to the desired ZMP trajectory.

Thus, any of the position, the velocity and/or the acceleration of the manipulator arm and/or the rotation position, rotation velocity and rotation acceleration of the manipulator base or combinations thereof may be adjusted, which may accordingly enable a flexible stability adjustment of the mobile manipulator.

In a preferred embodiment, the method further comprises the step of obtaining from the first control function, the joint accelerations of the manipulator arm “\ddot{q}_{M}” as an output and executing a movement trajectory of the mobile manipulator based on that output.

However, also different outputs may be obtained, such as the state of velocity “\dot{q}_{M}” of the manipulator arm or the state of position “q_{M}” of the manipulator arm and an execution of the movement trajectory of the mobile manipulator may be based on that different output.

In a preferred embodiment, after executing a movement trajectory of the mobile manipulator based on that output, the method further comprises the step of using the joint states of position and velocity “q_{M}, \dot{q}_{M}” of the manipulator arm as an input for the first control function.

Also, different inputs may be used as an input for the first control function, such as the state of acceleration “\ddot{q}_{M}” of the manipulator arm. In other words, a selected one of “\ddot{q}_{M}, \dot{q}_{M}, q_{M}”, i.e. the joint states of acceleration, velocity and position of the manipulator arm, may be obtained as an output from the first control function and the other ones of “\ddot{q}_{M}, \dot{q}_{M}, q_{M}” may be used as an input for the first control function. Thus, a dynamic re-adjustment of the executed trajectory, e.g. during movement of the mobile manipulator, may be achieved.

In a preferred embodiment, the method further comprises the step of obtaining from the first control function, the joint rotational accelerations of the manipulator base “\ddot{q}_{BR}” as an output and executing a movement trajectory of the mobile manipulator based on that output.

However, also different outputs may be obtained, such as the state of rotational velocity “\dot{q}_{BR}” of the manipulator base or the state of rotational position “q_{BR}” of the manipulator base and an execution of the movement trajectory of the mobile manipulator may be based on that different output.

In a preferred embodiment, after executing a movement trajectory of the mobile manipulator based on that output, the method further comprises the step of using the joint states of rotational position and velocity “q_{BR}, \dot{q}_{BR}” of the manipulator base as an input for the first control function.

Also, different inputs may be used as an input for the first control function, such as the state of rotational acceleration “\ddot{q}_{BR}” of the manipulator base. In other words, a selected one of “\ddot{q}_{BR}, \dot{q}_{BR}, q_{BR}”, i.e. the rotational position, rotational velocity and rotational acceleration of the manipulator base, may be obtained as an output from the first control function and the other ones of “\ddot{q}_{BR}, \dot{q}_{BR}, q_{BR}” may be used as an input for the first control function. Thus, a dynamic re-adjustment of the executed trajectory, e.g. during movement of the mobile manipulator, may be achieved.

In a preferred embodiment, the step of adjusting the mobile manipulator is based on the following second control function:

$$\int f ( {ZMP}_{real} ( {\ddot{q}}_{M} , {\dot{q}}_{M} , {q}_{M} , {\ddot{q}}_{B R} , {\dot{q}}_{B R} , {q}_{B R} , t ) , {ZMP}_{d e s} ( t ) ) d s = min e$$

Thus, the second control function, which may also be referred to as planning function, may be employed, which may improve the control of the mobile manipulator further. Based on the motion of the mobile base, a reference trajectory of the ZMP may be defined over the whole path. Thus, based on potential movements of the manipulator arm and potential rotations of the manipulator base, a movement of the mobile manipulator may be pre-set or planned before the mobile manipulator executes a movement along the movement trajectory.

In a preferred embodiment, the method further comprises the step of obtaining from the second control function, the desired state of the manipulator arm “(\ddot{q}_{M}, \dot{q}_{M}, q_{M}, \ddot{q}_{BR}, \dot{q}_{BR}, q_{BR})_{des}(t)” as an output.

In a preferred embodiment, the output of the second control function is used as an input to adjust the mobile manipulator such that the real ZMP trajectory of the mobile manipulator corresponds to the desired ZMP trajectory, or the output of the second control function is used as an input for the first control function. In other words, the result or output of the second control function may be used as standalone input or as a feed forward term for the first control function to improve the mobile manipulator control strategies disclosed herein.

Optionally, the mobile manipulator may comprise one or more variable mass elements, wherein the step of adjusting a center of mass of the mobile manipulator may include an adjustment of the variable mass elements, wherein the method may further comprise the step of using a discrete mass parameter “mₑₓₜᵣₐ” as an input variable for the first control function and/or the second control function. Thus, the additional mass may be considered in the planning and/or control of the manipulator, which may increase the influence on the manipulator motions. Thus, the mobile manipulator may be adjusted in addition or alternatively to the dynamic adjustment of the arm configuration and/or the rotation of the manipulator base by the additional masses, which may increase the flexibility, and which may extend the limits of the stabilizing adjustment. Thus, the mobile manipulator may be adjusted in addition or alternatively to the adjustment of the arm configuration of the mobile manipulator and/or the rotation of the manipulator base, which may increase the flexibility, and which may extend the limits of the stabilizing adjustment. The variable mass elements may be positioned at different distinct positions at the mobile manipulator to influence and adjust the center of mass of the mobile manipulator. The variable mass element may comprise a fixed weight or may have a variable weight, which may be adapted. The variable mass element may be a single mass element or may comprise multiple mass elements, which may be individually adjustable. Further, also a plurality of different weights may be provided depending on the need for adjustment of the mobile manipulator. The mass elements may be provided at any suitable position at the mobile manipulator, e.g. at an outer side of a housing, for instance at the top side or inside a housing the mobile manipulator. The mass elements may be adjusted manually by a user or automatically to one or more positions. The mass elements may be suitably adapted to the weight or dimensions of the mobile manipulator, for instance in a way that a proper stabilization of the mobile manipulator could be achieved while avoiding unnecessary weight.

In a preferred embodiment, the step of adjusting the mobile manipulator comprises a dynamic movement, which is controlled by the following second control function:

$$\int f ( {ZMP}_{real} ( q , \dot{q} , \ddot{q} , t ) , {ZMP}_{d e s} ( t ) ) ds = min e$$

wherein “q, \dot{q}, \ddot{q}” are the joint states of position, velocity and acceleration of the mobile manipulator, wherein, when the movement of the mobile manipulator is delimited by a corridor, the first control function and/or the second control function comprise an additional constraint:

$$f ( {q}_{B} , {\dot{q}}_{B} , {\ddot{q}}_{B} , t ) < corridor$$

wherein “q_{B}, \dot{q}_{B}, \ddot{q}ₚ” are the degrees of freedom of the position, the velocity and the acceleration of the manipulator base and “corridor” is a constraint value defined by the dimensions of the corridor the mobile manipulator is moving through.

In one embodiment, the step of adjusting the mobile manipulator comprises a dynamic movement, which is controlled by the following first control function:

$$f ( {ZMP}_{real} ( q , \dot{q} , \ddot{q} , t ) , {ZMP}_{d e s} ( t ) ) = min e$$

wherein the first control function comprises as an additional constraint:

$$f ( {q}_{B} , {\dot{q}}_{B} , {\ddot{q}}_{B} , t ) < corridor$$

Thus, the motion of the mobile manipulator may be suitably controllable if a respective corridor should be considered for the movement of the mobile manipulator. A corridor may be understood as an area on the ground, which is delimited by certain boundaries, which the mobile manipulator should not pass. Thus, the desired movement trajectory may be necessarily located within said corridor and the mobile base may be accordingly controlled to follow the desired movement trajectory within the corridor. In other words, the movement of the mobile manipulator may be restricted in that only a certain positioning, velocity and/or acceleration of the manipulator base may be allowed. The corridor may delimit the movement of the manipulator on one or more sides, e.g. at two opposing sides with a longitudinal path in between. The limitations may be achieved by respective real blocking means, such as walls. However, the corridor may also be defined virtually, such that no real blocking means are provided but that the mobile manipulator should not cross respective boundary lines or borders of the corridor. This may be useful, for instance, if a mobile manipulator works in a logistic or industrial side, wherein it should be only allowed to move along certain paths or streets. The corridor may have any desired shape e.g. in form of a longitudinal path, which may be straight or curved or have any other arbitrary shape.

The invention further relates to a mobile manipulator, comprising a manipulator base and at least one manipulator arm, and a control means adapted to control the mobile manipulator in accordance with the method of the present disclosure.

Thus, a mobile manipulator may be provided, wherein the movement of the mobile manipulator may be dynamically adjusted. It is noted that the above explanations regarding certain elements or advantages described with respect to the method of controlling a mobile manipulator of the present disclosure accordingly apply to the mobile manipulator described herein. Thus, a mobile manipulator, which is particularly stable during the movement may be provided. The control means may be arranged at the mobile manipulator or at least partially outside and remote to the mobile manipulator. The control means may comprise respective sensors or detectors to determine a position or movement of the respective elements. The determination of any configuration of the mobile manipulator and/or the determination or prediction of any parameters, such as the current configuration of the mobile manipulator, the desired movement trajectory, the determination of the ZMP, the current or desired ZMP trajectory and so forth, may be performed by respective computational means, which may or may not be part of control means of the mobile manipulator. The mobile manipulator may comprise one or more tools arranged at the distal end of the manipulator arm to perform respective manipulating actions, such as for instance picking and lifting an item and transporting and placing said item at a different position.

In a preferred embodiment, the mobile manipulator is an autonomous mobile manipulation robot, preferably comprising more than two steerable wheels.

Thus, a flexible and reliably stabilizable autonomous mobile manipulation robot is provided. This may include any type of manipulation robot, such as a mobile manipulator which may be movable over the ground. The movement of the robot along the ground and the movement of the arm may be fully or semi-automatically controlled. At least more than two steerable wheels may allow for a particularly well controlled movement over the ground. The wheels may be jointly or independently propellable or steerable. The mobile manipulation robot may be an industrial robot, a logistic robot, a medical robot, a laboratory robot or any other kind of robot, working in a respective industrial, logistic, medical or laboratory environment, that may use one or more manipulation arms arranged on a movable manipulator base to execute the desired tasks.

The invention further relates to a computer-program product comprising instructions, which, when executed by a computer, cause the computer to carry out and/or control any of the methods of the present disclosure.

The features of the system according to the present invention may be implemented by respective suitable digital or computational means, which can include, for instance, one or more computers, apps and/or networks.

The method may be at least partly computer-implemented, and may be implemented in software or in hardware, or in software and hardware. Further, the method may be carried out by computer program instructions running on means that provide data processing functions.

The data processing means may be a suitable computing means, such as an electronic control module etc., which may also be a distributed computer system. The data processing means or the computer, respectively, may comprise one or more of a processor, a memory, a data interface, or the like.

The invention further relates to a computer-readable medium comprising instructions which, when executed by a computer, cause the computer to carry out and/or control any of the methods of the present disclosure.

Any of the computer, the computer-program product and/or the computer-readable medium may be at least part of the mobile manipulator or may be arranged remotely to the mobile manipulator.

The features and advantages outlined above in the context of the system and the method similarly apply to the computer program product and the computer-readable medium described herein. Likewise, any features and advantages noted with regard to the method of to the present invention apply according to the mobile manipulator of the present invention and vice versa.

A computer program may be stored/distributed on a suitable medium such as an optical storage medium or a solid-state medium, supplied together with or as part of other hardware, but may also be distributed in other forms, such as via the Internet or other wired or wireless telecommunication systems.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### LIST OF REFERENCE SIGNS

1 mobile manipulator
3 manipulator base
5 manipulator arm
7 control means
9 contact elements
11 ground
13 mass elements
15 tool center point
50 movement of mobile base
100 computer
200 computer program product
300 computer readable medium
S1 to S21 method steps

What is claimed is:

1. A method for controlling a mobile manipulator comprising a manipulator base and at least one manipulator arm, the method comprising:
determining a current configuration of the mobile manipulator including a manipulator arm configuration and a manipulator base configuration;
determining a desired movement trajectory of the mobile manipulator;
determining a current zero-movement points (ZMP) trajectory, comprising the location of one or more current ZMP of the mobile manipulator, based on the current configuration of the mobile manipulator and the desired movement trajectory;
determining a desired ZMP trajectory of the mobile manipulator, wherein each ZMP is located within a support polygon of the manipulator base;
adjusting the mobile manipulator such that the current ZMP trajectory corresponds to the desired ZMP trajectory;
wherein the adjusting the mobile manipulator comprises a dynamic manipulator arm movement, which is controlled by the following first control function:
$$f ( {ZMP}_{real} ( {\ddot{q}}_{M} , {\dot{q}}_{M} , {q}_{M} , {\ddot{q}}_{B R} , {\dot{q}}_{B R} , {q}_{B R} , t ) , {ZMP}_{d e s} ( t ) ) = min e$$
wherein “ZMP_{des}(t)” is the desired ZMP trajectory; “ZMP real” is the real ZMP trajectory; “t” is a time; “\ddot{q}_{M}, \dot{q}_{M}, q_{M},” are joint states of acceleration, velocity and position of the manipulator arm (5); “q_{BR}, \dot{q}_{BR}, \ddot{q}_{BR}” are a rotational position, rotational velocity and rotational acceleration of the manipulator base (3), and “e” is a deviation of the real ZMP trajectory from the desired ZMP trajectory.

2. The method according to claim 1, wherein the method further comprises the step of using “q₀, \dot{q}₀, \ddot{q}₀” as input variables for the first control function, wherein “q₀, \dot{q}₀, \ddot{q}₀” are the initial states of position, velocity and acceleration of the mobile manipulator.

3. The method according to claim 1, wherein the method further comprises using the first control function to adjust one or more of the position, velocity and acceleration of the manipulator arm and/or the rotation position, rotation velocity and rotation acceleration of the manipulator base to adjust the mobile manipulator such that the real ZMP trajectory of the mobile manipulator corresponds to the desired ZMP trajectory.

4. The method according to claim 1, wherein the method further comprises obtaining from the first control function, the joint accelerations of the manipulator arm “\ddot{q}_{M}” as an output, and executing a movement trajectory of the mobile manipulator based on that output.

5. The method according to claim 4, wherein, after executing a movement trajectory of the mobile manipulator based on the output, using the joint states of position and velocity “q_{M}, \dot{q}_{M}” of the manipulator arm as an input for the first control function.

6. The method according to claim 1, wherein the method further comprises obtaining from the first control function, the joint rotational accelerations of the manipulator base “\ddot{q}_{BR}” as an output, and executing a movement trajectory of the mobile manipulator based on that output.

7. The method according to claim 6, wherein, after executing a movement trajectory of the mobile manipulator based on the output, the method further comprises using the joint states of rotational position and velocity “q_{BR}, \dot{q}_{BR}” of the manipulator base as an input for the first control function.

8. The method according to claim 1, wherein step of adjusting the mobile manipulator is based on the following second control function:
$$\int f ( {ZMP}_{real} ( {\ddot{q}}_{M} , {\dot{q}}_{M} , {q}_{M} , {\ddot{q}}_{B R} , {\dot{q}}_{B R} , {q}_{B R} , t ) , {ZMP}_{d e s} ( t ) ) ds = min e .$$

9. The method according to claim 8, wherein the method further comprises obtaining from the second control function, the desired state of the manipulator arm “(\ddot{q}_{M}, \dot{q}_{M}, q_{M}, \ddot{q}_{BR}, \dot{q}_{BR}, q_{BR}) _{des}(t)” as an output.

10. The method according to claim 9, wherein the output of the second control function is used as an input to adjust the mobile manipulator such that the real ZMP trajectory of the mobile manipulator corresponds to the desired ZMP trajectory, or wherein the output of the second control function is used as an input for the first control function.

11. The method according to claim 1, wherein the step of adjusting the mobile manipulator comprises a dynamic movement, which is controlled by the following second control function:
$$\int f ( {ZMP}_{real} ( q , \dot{q} , \ddot{q} , t ) , {ZMP}_{d e s} ( t ) ) ds = min e ,$$
wherein “q, \dot{q}, \ddot{q}” are the joint states of position, velocity and acceleration of the mobile manipulator,
wherein, when the movement of the mobile manipulator is delimited by a corridor, the first control function and/or the second control function comprise an additional constraint:
$$f ( {q}_{B} , {\dot{q}}_{B} , {\ddot{q}}_{B} , t ) < corridor ,$$
wherein “q_{B}, \dot{q}_{B}, \ddot{q}_{B}” are the degrees of freedom of the position, the velocity and the acceleration of the manipulator base and “corridor” is a constraint value defined by the dimensions of the corridor the mobile manipulator is moving through.

12. A mobile manipulator, comprising:
a manipulator base;
at least one manipulator arm; and
a control means adapted to control the mobile manipulator in accordance with a method for controlling a mobile manipulator comprising a manipulator base and at least one manipulator arm, the method comprising:
determining a current configuration of the mobile manipulator including a manipulator arm configuration and a manipulator base configuration;
determining a desired movement trajectory of the mobile manipulator;
determining a current zero-movement points (ZMP) trajectory, comprising the location of one or more current ZMP of the mobile manipulator, based on the current configuration of the mobile manipulator and the desired movement trajectory;
determining a desired ZMP trajectory of the mobile manipulator, wherein each ZMP is located within a support polygon of the manipulator base;
adjusting the mobile manipulator such that the current ZMP trajectory corresponds to the desired ZMP trajectory;
wherein the adjusting the mobile manipulator comprises a dynamic manipulator arm movement, which is controlled by the following first control function:
$$f ( {ZMP}_{real} ( {\ddot{q}}_{M} , {\dot{q}}_{M} , {q}_{M} , {\ddot{q}}_{B R} , {\dot{q}}_{B R} , {q}_{B R} , t ) , {ZMP}_{d e s} ( t ) ) = min e$$
wherein “ZMP_{des}(t)” is the desired ZMP trajectory; “ZMPᵣₑₐₗ” is the real ZMP trajectory; “t” is a time; “\ddot{q}_{M}, \dot{q}_{M}, q_{M},” are joint states of acceleration, velocity and position of the manipulator arm (5); “q_{BR}, \dot{q}_{BR}, \ddot{q}_{BR}” are a rotational position, rotational velocity and rotational acceleration of the manipulator base (3), and “e” is a deviation of the real ZMP trajectory from the desired ZMP trajectory.

13. The mobile manipulator according to claim 12, wherein the mobile manipulator is an industrial autonomous mobile manipulation robot comprising more than two steerable wheels.

14. A computer-readable medium comprising instructions which, when executed by a computer, cause the computer to carry out a method for controlling a mobile manipulator comprising a manipulator base and at least one manipulator arm, the instructions comprising:
instructions for determining a current configuration of the mobile manipulator including a manipulator arm configuration and a manipulator base configuration;
instructions for determining a desired movement trajectory of the mobile manipulator;
instructions for determining a current zero-movement points (ZMP) trajectory, comprising the location of one or more current ZMP of the mobile manipulator, based on the current configuration of the mobile manipulator and the desired movement trajectory;
instructions for determining a desired ZMP trajectory of the mobile manipulator, wherein each ZMP is located within a support polygon of the manipulator base;
instructions for adjusting the mobile manipulator such that the current ZMP trajectory corresponds to the desired ZMP trajectory;
wherein the adjusting the mobile manipulator comprises a dynamic manipulator arm movement, which is controlled by the following first control function:
$$f ( {ZMP}_{real} ( {\ddot{q}}_{M} , {\dot{q}}_{M} , {q}_{M} , {\ddot{q}}_{B R} , {\dot{q}}_{B R} , {q}_{B R} , t ) , {ZMP}_{d e s} ( t ) ) = min e$$
wherein “ZMP_{des}(t)” is the desired ZMP trajectory; “ZMPᵣₑₐₗ” is the real ZMP trajectory; “t” is a time; “\ddot{q}_{M}, \dot{q}_{M}, q_{M},” are joint states of acceleration, velocity and position of the manipulator arm (5); “q_{BR}, \dot{q}_{BR}, \ddot{q}_{BR}” are a rotational position, rotational velocity and rotational acceleration of the manipulator base (3), and “e” is a deviation of the real ZMP trajectory from the desired ZMP trajectory.
